(19) United States
(12) Patent Application Publication
(10) Pub. No.: US 2026/0136399 A1
(43) Pub. Date: May 14, 2026

(54) CONTENTION-FREE ADAPTIVE RANDOM ACCESS BASED ON DYNAMIC ALLOCATION OF PREAMBLES

(71) Applicant: T-Mobile USA, Inc., Bellevue, WA (US)

(72) Inventors: Roopesh Kumar Polaganga, Bothell, WA (US); Sanjay Baburao Waje, Plano, TX (US); Kurt Michael Landuyt, Parkville, MO (US)

(21) Appl. No.: 18/943,607

(22) Filed: Nov. 11, 2024

(51) Int. Cl. H04W 74/0833; H04W 24/02; H04W 36/00; H04W 64/00

(52) U.S. Cl. CPC H04W 74/0833; H04W 24/02; H04W 36/0072; H04W 64/003

(57) ABSTRACT

The disclosed technology enables contention-free adaptive random access based on dynamic allocation of Random Access preambles. Upon retrieving usage data associated with multiple endpoint devices, a network node of a communication network predicts a demand for a connection associated with a service provided by the communication network by applying a model to the usage data. Based on the predicted demand for the connection associated with the service, the network node dynamically allocates a set of Random Access preambles for the connection.

### BACKGROUND

Random Access (RA) is an essential part of wireless communications systems that plays a significant role in establishing communication between a user device and a network. The communication can include an initial connection, also known as Initial Access, which refers to a sequence of processes performed between the user device and the network in order for the user device to establish uplink synchronization. The communication can also include re-establishment procedures to re-establish communication between the user device and the network, or a handover, which is a process of transferring a session of the user device from one network to another network.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3A is a flowchart representation of an example contention-based Random Access (RA) procedure.

FIG. 3B is a flowchart representation of an example contention-free RA procedure initiated by a network.

FIG. 4 is a flowchart representation of an example contention-free adaptive RA process based on dynamic allocation of preambles in accordance with one or more embodiments of the present technology.

FIG. 5 illustrates an example model implementation platform implementing a model applied by a network in accordance with one or more embodiments of the present technology.

FIG. 6 is a flowchart representation of an example allocation process of RA preambles based on a demand for a service predicted by a model in accordance with one or more embodiments of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Contention-free Random Access (RA) procedures enable improved reliability and reduced latency by eliminating or significantly reducing the possibility of data collisions. However, contention-free RA procedures require network nodes to pre-allocate dedicated preambles and resources, which can result in inefficient allocation of resources especially in scenarios with dynamic and variable traffic patterns. As such, it is desirable to dynamically allocate the preambles and resources based on real-time or near real-time network conditions and demand associated with endpoint devices.

The technology disclosed herein relates to a method for performing contention-free adaptive RA procedures based on dynamic allocation of preambles. A network can predict a demand for a particular service by using a model that is trained using usage data of endpoint devices. The preambles can be dynamically allocated based on the predicted demand and other information available to the network, such as pre-defined prioritization information, service requirements, real-time or near real-time network conditions, capability information associated with one or more of the endpoint devices, and indication of urgency associated with the one or more of the endpoint devices, thereby improving the efficiency and reliability of connection establishments.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

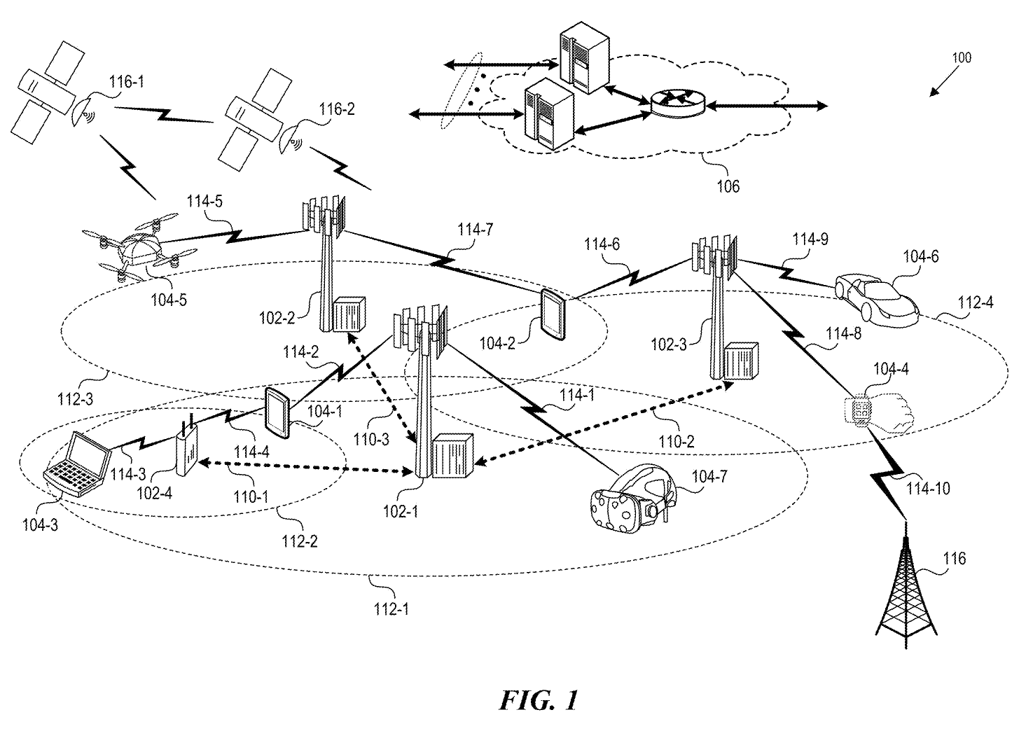

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

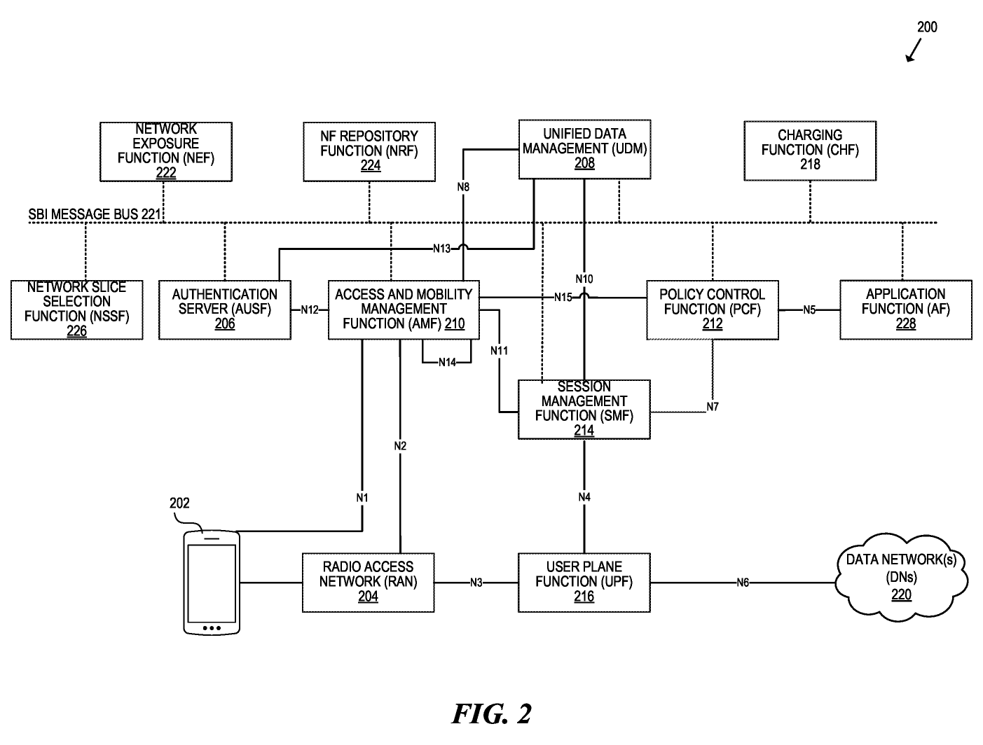

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Contention-Free Adaptive Random Access Based on Dynamic Allocation of Preambles

In telecommunications, data transmission from a user device can happen in two ways: 1) when the user device has a dedicated RRC connection, and 2) when the user device needs to access the network and then begins data transmission. When no dedicated connection is established, a scheduling request will be transmitted on Random Access Channel (RACH), also referred to as Random Access Scheduling request (RA_SR). The process of accessing the network when no dedicated RRC is established, or when the user device performs a transmission for the first time, is called Random Access (RA).

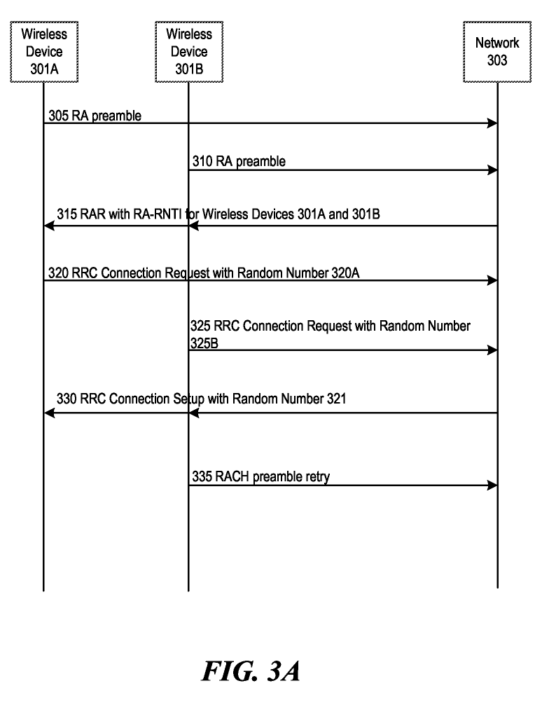

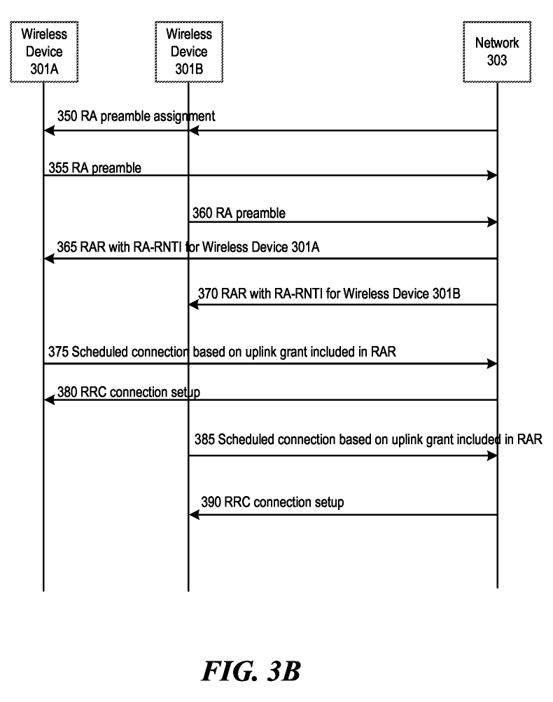

RA can largely be grouped into two types: contention-based RA and contention-free RA. FIG. 3A is a flowchart representation of an example contention-based RA procedure. Contention-based RA, as shown in FIG. 3A, refers to a scenario where there is a contention to access a network because multiple user devices are using the same RA preamble to access the network at the same time. Contention-free RA is a process initiated by the network wherein the network reserves a set of preambles to prevent contentions among the multiple user devices.

In the example illustrated in FIG. 3A, at Operation 305, a wireless device 301A selects a RA preamble and transmits the RA preamble to a network 303. The RA preamble represents a random user equipment identification (UE ID) that can subsequently be used by the network 303 when granting the wireless device 301A access to the network 303. Multiple RA preambles exist to enable the network 303 to distinguish between different devices performing random access. At Operation 310, a wireless device 301B selects the same RA preamble and transmits the RA preamble to the network 303. At Operation 315, because both of the wireless devices 301A-B transmitted the same RA preamble to the network 303, the network 303 sends the same Random Access Response (RAR) with Random Access-Radio Network Temporary Identifier (RA-RNTI) to both wireless device 301A and wireless device 301B. The RAR can include timing advance instructions, an initial uplink grant, and a temporary Cell Radio Network Temporary Identifier (C-RNTI).

At Operation 320, upon receiving the RAR from the network 303, the wireless device 301A initiates an RRC connection request with a random number 320A. At Operation 325, the wireless device 301B, upon receiving the RAR from the network 303, also initiates an RRC connection request with a random number 325B. However, because the RARs sent by the network 303 to the wireless devices 301A-B are intended for wireless device 301A and not for wireless device 301B, the network 303 is unable to decode the request from the wireless device 301B. At Operation 330, the network 303 sends an RRC connection setup with the random number 320A. The network 303 also sends an RRC connection setup with the random number 320A to the wireless device 301B. At this point, the wireless device 301B realizes that another wireless device has established a connection with the network 303. At Operation 335, the wireless device 301B begins the RA preamble retry process to establish a connection with the network 303.

FIG. 3B is a flowchart representation of an example contention-free RA procedure initiated by the network 303. At Operation 350, the network 303 initiates the contention-free RA procedure by assigning dedicated RA preambles to each of the wireless devices 301A-B. At Operation 355, the wireless device 301A transmits the RA preamble assigned by the network 303 to the network 303. Similarly, at Operation 360, the wireless device 301B transmits the RA preamble assigned by the network 303 to the network 303. At Operation 365, the network 303 sends a RAR with RA-RNTI for wireless device 301A to the wireless device 301A. At Operation 370, the network 303 sends a RAR with RA-RNTI for wireless device 301B to the wireless device 301B. At Operation 375, the wireless device 301A uses an uplink grant included in the RAR to schedule and initiate an RRC connection request. At Operation 380, upon receiving the RRC connection request, the network 303 processes the RRC connection request from the wireless device 301A and sends an RRC connection setup to the wireless device 301A to establish connection between the network 303 and the wireless device 301A.

Similarly, in Operation 385, the wireless device 301B uses an uplink grant included in the RAR to schedule and initiate an RRC connection request. At Operation 390, upon receiving the RRC connection request, the network 303 processes the RRC connection request from the wireless device 301B and sends an RRC connection setup to the wireless device 301B to establish connection between the network 303 and the wireless device 301B. The contention-free RA procedure allows multiple wireless devices to connect to the network 303 without contention, ensuring a smooth and efficient connection process.

While contention-free RA provides benefits in terms of reduced latency and increased reliability, contention-free RA procedures are not without limitations. Contention-free RA requires network nodes to pre-allocate dedicated preambles and resources for specific user devices. The pre-allocation of dedicated preambles and resources can be inefficient, especially in scenarios with dynamic and unpredictable traffic patterns. Moreover, the number of dedicated preambles is limited. For networks with high density, assigning dedicated preambles to user devices within the network may not be feasible. Alternatively, in some scenarios, not all of the assigned dedicated preambles may be used, e.g., due to changes in network conditions or user behavior. Additionally, ensuring that the dedicated preambles are correctly assigned and managed requires additional coordination between the networks and the user devices, which can introduce overhead and complexity. Some of the user devices may be reduced capability (RedCap) devices with limited capabilities, rendering contention-free RA unsuitable.

This document discloses techniques that can be implemented in various embodiments to address the challenges of contention-free RA. In some embodiments, contention-free adaptive RA can be configured to optimize services, such as Initial Access process and/or handovers, by dynamically allocating dedicated random-access resources based on real-time or near real-time network conditions and device requirements.

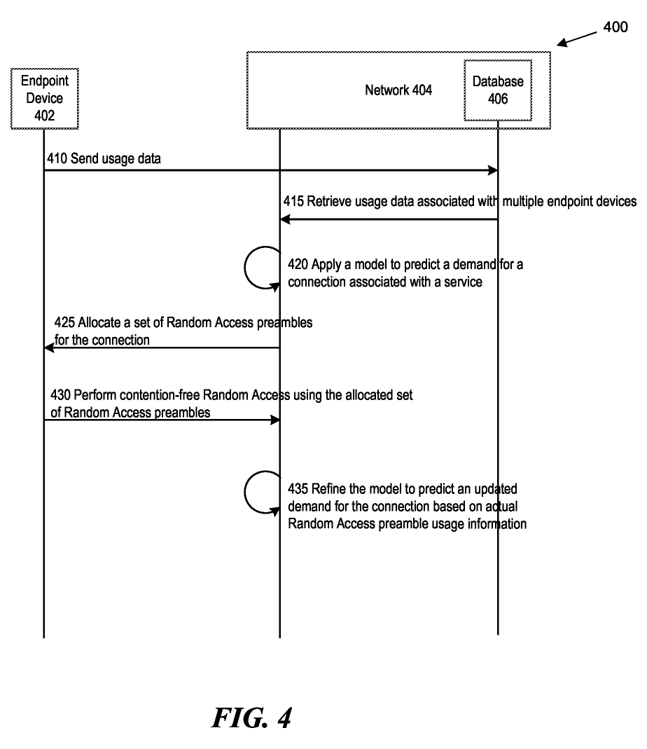

FIG. 4 is a flowchart representation of an example contention-free adaptive RA process 400 based on dynamic allocation of preambles in accordance with one or more embodiments of the present technology. Other implementations of the process 400 include additional, fewer, or different network components and/or additional, fewer, or different steps or involve performing the steps in different orders.

In the example illustrated in FIG. 4, endpoint devices associated with a network 404, such as an endpoint device 402, at Operation 410, are configured to periodically send usage data for storage to a database 406 of the network 404. The usage data can include historical and contextual data associated with the endpoint devices, such as usages for handover, carrier aggregation, and dual connectivity using secondary cell(s)/cell groups. The usage data can also include location session records identifying endpoint devices associated with a session, location information, session details such as session start and end time, duration, and data usage information, network information, and service information identifying the type of connection and service and quality of service (QoS) associated with the session.

At Operation 415, the network 404 retrieves the usage data associated with the endpoint devices from the database 406. Subsequently, at Operation 420, the network 404 applies a model to the retrieved usage data to predict a demand for certain connection types or service types (e.g., carrier aggregation, dual connectivity, network slicing related service types). The usage data also includes information regarding device types, such as regular devices and devices with reduced capacities (RedCap devices). The model can be a rule-based model or a trained machine learning (ML) model. A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

One or more of the machine learning models described herein can be trained with supervised learning, where the training data includes the usage data of the endpoint devices as input and a desired output, such as the predicted demand for a particular service requested by one or more endpoint devices. Additionally, in some implementations, actual usage information, as identified by one or more endpoint devices or the network 404, can be provided to the model to allow the model to calculate a deviation of the predicted demand for the service with the actual usage information of the endpoint devices. Based on the deviation, the model can be modified, such as by changing parameters of the functions used, to calculate an updated demand for the particular service based on the actual usage information.

In some implementations, pre-defined prioritization information per device type (e.g., RedCap devices), connection type, and/or service type (carrier aggregation, network slicing, etc.) can be embedded in the model as parameter weights. For example, connection requests for emergency services and critical IoT applications may be assigned greater weight due to their urgency as compared to a connection requested by an endpoint device for non-emergency services. The pre-defined prioritization information can be implemented along with a dynamic allocation algorithm to output a predicted demand for a connection associated with a particular service provided by the network 404. Additionally, applying the model can further include identifying indications of the demand for the connection based on the usage data of the endpoint devices. In some implementations, the network 404 validates the model and the predicted demand using another usage data associated with the endpoint devices.

At Operation 425, based on the predicted demand for the connection associated with the service, the network 404 can allocate a set of Random Access preambles within a pool of preambles available in the network 404. For example, upon determining that a demand for handovers for a particular network node is predicted to be higher than normal during a 1-hour period starting from noon (e.g., due to mobility events associated with the corresponding endpoint devices), the network 404 can allocate 24 preambles for handovers out of 64 preambles available, as compared to the 16 preambles normally allocated for handovers for the particular network node. In some implementations, the allocation of the set of Random Access preambles is further based on other factors, such as pre-defined prioritization information defining prioritization rules associated with each endpoint device or requirements of the service to be performed. The allocation can be further based on real-time or near real-time network conditions, capability information associated with the endpoint devices, and indications of urgency associated with one or more of the endpoint devices.

The service provided by the network 404 is not limited to handovers and can include other RRC reconfigurations such as carrier aggregation, dual connectivity, and network slicing reconfigurations. Following a demand by endpoint devices for a connection associated with carrier aggregation, the network 404 can allocate Random Access preambles for use on secondary cells, ensuring the endpoint devices can access secondary cells without delay and risk of collision with other endpoint devices. In some implementations, upon receiving the Random Access preambles from the endpoint devices, the network 404 can be configured to send Random Access Responses to the endpoint devices including timing advance information. The timing advance information is used by the endpoint devices to adjust transmission timing to ensure synchronization with the secondary cell. In another example, in response to a demand for a connection associated with dual connectivity, the network 404 can dynamically assign specific Random Access preambles to endpoint devices for a secondary cell based on the identified demand, ensuring access to the secondary cell without contention.

In other implementations, the demand predicted by the model is a demand for connection associated with network slicing reconfigurations. Each network slice is tailored to meet specific endpoint device requirements and/or connection requirements. The network 404 can dynamically assign a set of Random Access preambles to endpoint devices associated with each network slice, ensuring no contention between endpoint devices from different network slices. The network 404 can allocate the set of Random Access preambles further based on priorities associated with each network slice.

At Operation 430, the endpoint devices, such as the endpoint device 402, use the dedicated preambles allocated by the network 404 to initiate and establish contention-free Random Access procedure with the network node of the network 404. In some implementations, the network 404 is configured to periodically monitor the set of Random Access preambles to obtain actual Random Access preamble usage information. At Operation 435, based on the actual Random Access preamble usage information, the network 404 refines the model to predict an updated demand for the connection associated with the service. For example, referring back to the above example of allocating 24 preambles in response to a prediction of high demand for handovers, upon determining that only 12 preambles were utilized by the endpoint devices for handovers during the 1-hour period, the network 404 can provide the usage data to the model to predict an updated demand for handovers. Based on the updated demand, the network 404 can allocate 12 preambles for handovers.

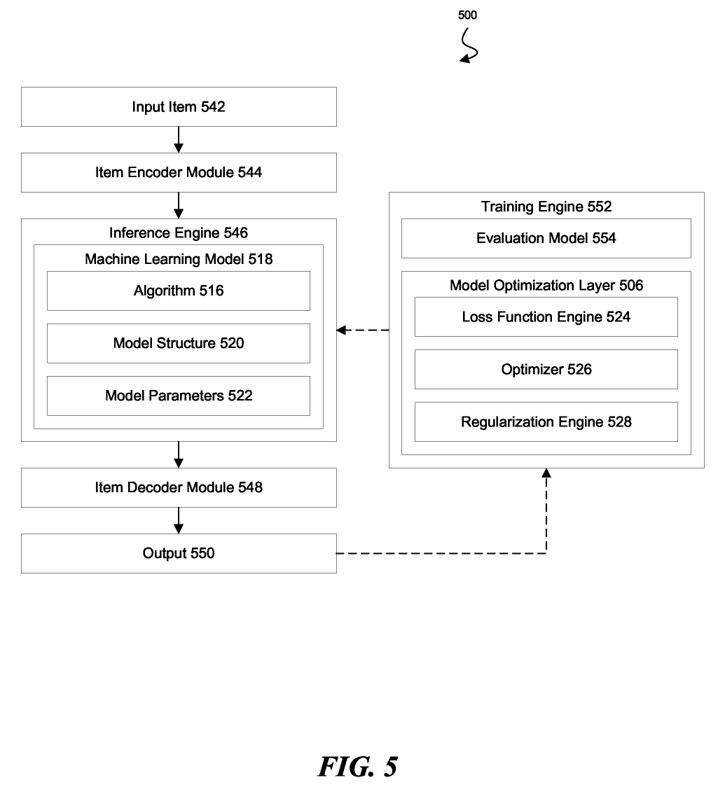

FIG. 5 illustrates an example model implementation platform 500 implementing the model applied by the network 404 in accordance with one or more embodiments of the present technology. According to various implementations, the model implementation platform 500 can include an inference engine 546 based on the machine learning model 518, algorithm 516, model structure 520, and model parameters 522. In additional or alternative implementations, the model implementation platform 500 can include a training engine 552 based on a separate evaluation model 554, the model optimization layer 506, loss function engine 524, optimizer 526, and regularization engine 528. In some embodiments, the model implementation platform 500 can include both the inference engine 546 and the training engine 552 in the workflow to train the model 518. In alternative or additional embodiments, the model implementation platform 500 can include the inference engine 546 without the training engine 552 in the workflow to make multiple model inferences without altering the model parameters 522.

The algorithm 516 can be an organized set of computer-executable operations used to generate output data from a set of input data and can be described using pseudocode. The algorithm 516 can include program code that allows the computing resources to learn from new input data and create new/modified outputs based on what was learned. Once trained, the algorithm 516 can run at the computing resources to make predictions or decisions, improve computing resource performance, or perform tasks. The algorithm 516 can be trained using supervised learning, unsupervised learning, semi-supervised learning, self-supervised learning, reinforcement learning, and/or federated learning.

Using supervised learning, the algorithm 516 can be trained to learn patterns (e.g., match input data to output data) based on labeled training data. Supervised learning can involve classification and/or regression. Classification techniques involve teaching the algorithm 516 to identify a category of new observations based on training data and are used when the input data for the algorithm 516 is discrete. Said differently, when learning through classification techniques, the algorithm 516 receives training data labeled with categories and determines how features observed in the training data relate to the categories. Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Federated learning (e.g., collaborative learning) can involve splitting the model training into one or more independent model training sessions, with each model training session assigned an independent subset training dataset of the training dataset. The one or more independent model training sessions can each be configured to train a previous instance of the model 518 using the assigned independent subset training dataset for that model training session. After each model training session completes training the model 518, the algorithm 516 can consolidate the output model, or trained model, of each individual training session into a single output model that updates the model 518. In some implementations, federated learning enables individual model training sessions to operate in individual local environments without requiring exchange of data to other model training sessions or external entities. Accordingly, data visible within a first model training session is not inherently visible to other model training sessions.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning-based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format. The platform can use unsupervised learning to identify patterns in input data.

The model implementation platform 500 can be configured to perform model inference on an input item 542 using the inference engine 546. For example, the model implementation platform 500 can supply the inference engine 546 with the input item 542 and generate an inference output item 550. In some embodiments, the model implementation platform 500 can supply the input item 542 to an item encoder module 544 to generate an encoded input item that is supplied to the inference engine 546 in lieu of the raw input item 542. In additional or alternative embodiments, the model implementation platform 500 can supply an immediate output item of the inference engine 546 to an item decoder module 548 to generate the output item 550. To clarify, in lieu of the immediate output item of the inference engine 546, the output item 550 can be generated as the decoded output of the item decoder module 548. In some embodiments, the model implementation platform 500 can include the item encoder module 544, item decoder module 548, and/or any combination thereof.

In some embodiments, the input item 542 provided to the model implementation platform 500 can include a character sequence (e.g., a text string of characters such as identification information and usage data of one or more endpoint devices), an image, an audio signal, a set of vectors, general data objects (e.g., a class instance comprising internal attributes and/or properties), and/or any combination thereof. In other embodiments, the output item 550 generated from the model implementation platform 500 can include an image and/or a set of images. In additional or alternative embodiments, the output item 550 can include a character sequence such as information related to a predicted demand for a particular service, an audio signal, a set of vectors, general data objects, and/or any combination thereof.

In some embodiments, the item encoder module 544 and item decoder module 548 of the model implementation platform 500 can be a discrete set of algorithmic instructions to convert a source data item to a converted data item. For example, if the input item 542 was a multi-dimensional array of size m by n, the item encoder module 544 can be configured with a discrete set of algorithmic instructions to flatten the shape of the input item 542 array into a 1 by m by n shape array. In additional or alternative embodiments, the item encoder module 544 and item decoder module 548 can be individual neural network model layers separate from the model 518. In other embodiments, the item encoder module 544 and item decoder module 548 can be configured to ensure that the properties (e.g., array shape) of the converted data item adhere to a specified set of properties. For example, the item encoder module 544 can be configured to ensure that the input item 542 is converted into an acceptable input pattern for the model 518.

The model implementation platform 500 can be configured to perform model training on the output item 550 using the training engine 552. For example, the model implementation platform 500 can supply the training engine 552 with the output item 550 and generate a loss value using the loss function engine 524. The model implementation platform 500 can use the loss value generated from the loss function engine 524 to change and/or modify the model parameters 522 of the model used by the inference engine 546. In additional or alternative embodiments, the training engine 552 can include an evaluation model 554 that is separate from the model 518. In some embodiments, the evaluation model 554 can generate a loss-compatible output item from the output item 550 that can be used to calculate the loss value using the loss function engine 524.

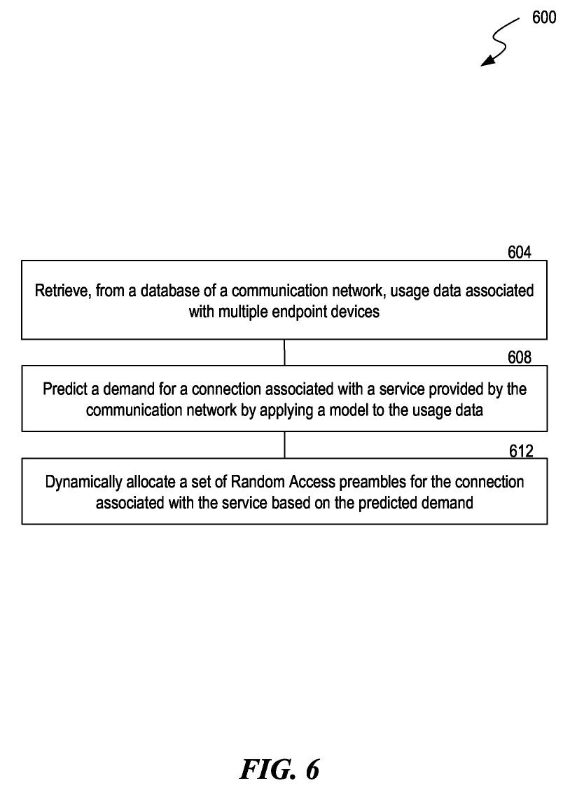

FIG. 6 is a flowchart representation of an example allocation process 600 of Random Access preambles based on a demand for a service predicted by a model in accordance with one or more embodiments of the present technology. Other implementations of the process 600 include additional, fewer, or different network components and/or additional, fewer, or different steps or involve performing the steps in different orders.

At Operation 604, a network node of a communication network retrieves, from a database of the communication network, usage data associated with multiple endpoint devices. The usage data retrieved by the network node can include all relevant historical and contextual data associated with the multiple endpoint devices that are stored in the database such as usages for handover, carrier aggregation, and dual connectivity using secondary cell(s)/cell groups. The usage data can include location session records of past sessions between the network and the multiple endpoint devices, such as information identifying endpoint devices associated with a session, location information, session details including session start and end time, duration, and data usage information, network information, and service information identifying the type of connection and service and QoS associated with the session.

At Operation 608, the network node applies a model to the usage data to predict a demand for certain connection types or service types (e.g., carrier aggregation, dual connectivity, network slicing related service types) provided by the communication network. The model can be a rule-based model or a trained machine learning model. The service provided by the communication network includes, but is not limited to, handovers involving transferring of a session from one network node to another, carrier aggregation, dual connectivity, and other Radio Resource Control (RRC) reconfiguration procedures. The model can be trained using historical usage data associated with the multiple endpoint devices to predict a demand for a connection associated with a particular service. Additionally, the model can be validated by the network node using another usage data associated with the multiple endpoint devices. In some implementations, the model utilizes feature engineering to identify indications of the demand for connection associated with a particular service, such as time of day, location, device density, device type, and type of service demanded.

In some implementations, the model can be further trained using pre-defined prioritization information based on a dynamic allocation algorithm that enables adaptive allocation of preambles by the communication network. The pre-defined prioritization information can assign different weight values to services based on service types (e.g., emergency, time-critical services). The model can be configured to implement pre-defined prioritization information along with the historical usage data to predict the demand for the connection associated with the service provided by the communication network. The prioritization information can include prioritization rules associated with each endpoint device, connection type, or requirements of the service to be performed. For example, emergency and time-critical services, or demand for connection for service by critical IoT applications, may be given a higher priority as compared to demand for connection for service by non-critical endpoint devices in a non-emergency situation.

At Operation 612, based on the predicted demand for the connection associated with the service, the network node allocates, within a pool of preambles available to the network node, a set of Random Access preambles for the connection associated with the service. In response to a higher-than-normal demand for the connection associated with the service, the network node can allocate more Random Access preambles for the connection than the number of Random Access preambles normally allocated for the connection. In response to a lower-than-normal demand for the service, the network node can allocate fewer Random Access preambles for the connection associated with the service.

In some implementations, the allocation of the set of Random Access preambles is further based on analysis of the pre-defined prioritization information, service requirements, real-time or near real-time network conditions, capability information associated with one or more of the multiple endpoint devices, and/or indication of urgency associated with the one or more of the multiple endpoint devices. For example, the network node can allocate the set of Random Access preambles dynamically by first considering the model’s predictions and further enhancing the predictions with real-time or near real-time conditions of the network node and/or endpoint devices to prioritize endpoint devices based on urgency and service requirements. In other implementations, the network node is configured to assign priorities to one or more of the endpoint devices based on subscription status of the one or more endpoint devices such that subscribed endpoint devices are given higher priority than unsubscribed endpoint devices.

In some implementations, the network node is configured to monitor the set of Random Access preambles to obtain actual Random Access preamble usage information. The actual Random Access preamble usage information can include information such as identification information of endpoint devices that transmitted the Random Access preambles, preamble transmission timing, preamble power level, and/or preamble repetition count. The actual Random Access preamble usage information can also include a success rate of Random Access attempts by one or more endpoint devices as well as a percentage value indicating efficiency of preamble usage. The network node can be further configured to update the model using the actual Random Access preamble usage information to output an updated predicted demand for the connection associated with the service provided by the communication network. In some implementations, the actual Random Access preamble usage information obtained through periodic monitoring of the set of Random Access preambles is periodically fed to the model as input to refine and retrain the model.

### Computer System

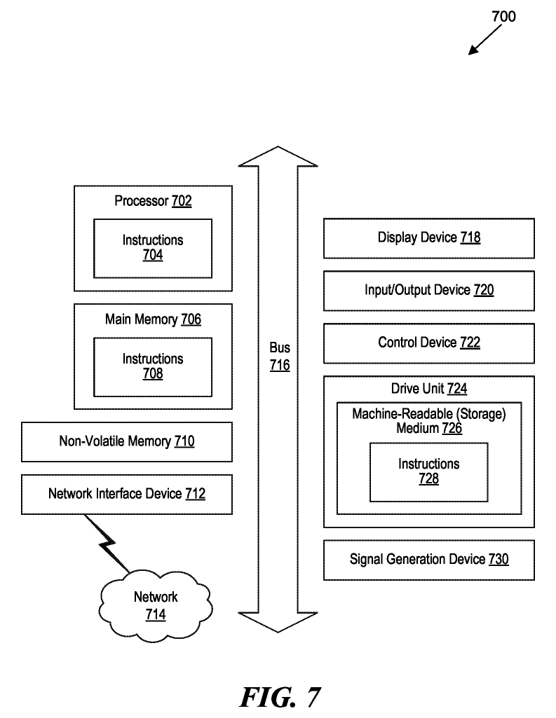

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A computer-implemented method for communicating information in a telecommunications network, comprising:
retrieving, from a database associated with the telecommunications network, usage data associated with multiple endpoint devices of the telecommunications network;
predicting a demand for a connection associated with a service provided by the telecommunications network by applying a machine learning model to the usage data,
wherein the machine learning model is trained using pre-defined prioritization information based on a dynamic allocation algorithm that enables adaptive allocation of preambles by the telecommunications network, and
wherein the pre-defined prioritization information assigns different weight values to services based on associated service types; and
dynamically allocating, within a pool of preambles of the telecommunications network, a set of Random Access (RA) preambles for the connection associated with the service based on the predicted demand for the service.

2. The method of claim 1, wherein the usage data includes location session records data associated with the multiple endpoint devices.

3. The method of claim 1, further comprising:
monitoring the set of RA preambles to obtain actual RA preamble usage information; and
updating the model using the actual RA preamble usage information.

4. The method of claim 1, further comprising:
validating the model using another usage data associated with the multiple endpoint devices.

5. The method of claim 1, wherein the machine learning model is a rule-based model or a trained machine learning model.

6. The method of claim 1, wherein the dynamic allocating of the set of RA preambles is further based on analysis of the pre-defined prioritization information, service requirements, real-time or near real-time network conditions, capability information associated with one or more of the multiple endpoint devices, and/or indication of urgency associated with the one or more of the multiple endpoint devices.

7. The method of claim 1, wherein the connection comprises at least one of a handover or a radio resource control (RRC) connection reconfiguration.

8. A non-transitory, computer-readable storage medium comprising instructions recorded thereon, wherein the instructions, when executed by at least one data processor of a system, cause the system to:
retrieve, from a database of a communications network, usage data associated with multiple endpoint devices of the communications network;
predict a demand for a connection associated with a service provided by the communications network by applying a model to the usage data,
wherein the model is trained using pre-defined prioritization information based on a dynamic allocation algorithm that enables adaptive allocation of preambles by the communications network, and
wherein the pre-defined prioritization information assigns different weight values to services based on associated service types; and
dynamically allocate, within a pool of preambles of the communications network, a set of Random Access (RA) preambles for the connection associated with the service based on the predicted demand for the service.

9. The non-transitory, computer-readable storage medium of claim 8, wherein the usage data includes location session records data associated with the multiple endpoint devices.

10. The non-transitory, computer-readable storage medium of claim 8, wherein the instructions further cause the system to:
monitor the set of RA preambles to obtain actual RA preamble usage information; and
update the model using the actual RA preamble usage information.

11. The non-transitory, computer-readable storage medium of claim 8, wherein the instructions further cause the system to:
validate the model using another usage data associated with the multiple endpoint devices.

12. The non-transitory, computer-readable storage medium of claim 8, wherein the model is a rule-based model or a trained machine learning model.

13. The non-transitory, computer-readable storage medium of claim 8, wherein the dynamic allocation of the set of RA preambles is further based on analysis of the pre-defined prioritization information, service requirements, real-time or near real-time network conditions, capability information associated with one or more of the multiple endpoint devices, and/or indication of urgency associated with the one or more of the multiple endpoint devices.

14. The non-transitory, computer-readable storage medium of claim 8, wherein the connection comprises at least one of a handover or a radio resource control (RRC) connection reconfiguration.

15. A system for telecommunication, the system comprising:
a database of a communication network configured to:
receive, from multiple endpoint devices of the communication network, usage data associated with the multiple endpoint devices; and
store the usage data; and
a network node of the communication network configured to:
retrieve, from the database of the communication network, the usage data associated with the multiple endpoint devices;
predict a demand for a connection associated with a service provided by the communication network by applying a model to the usage data,
wherein the model is trained using pre-defined prioritization information based on a dynamic allocation algorithm that enables adaptive allocation of preambles by the communication network, and
wherein the pre-defined prioritization information assigns different weight values to services based on service types; and
dynamically allocate, within a pool of preambles of the communication network, a set of Random Access (RA) preambles for the connection associated with the service based on the predicted demand for the service.

16. The system of claim 15, wherein the usage data includes location session records data associated with the multiple endpoint devices.

17. The system of claim 15, wherein the network node is further configured to:
monitor the set of RA preambles to obtain actual RA preamble usage information; and
update the model using the actual RA preamble usage information.

18. The system of claim 15, wherein the network node is further configured to:
validate the model using another usage data associated with the multiple endpoint devices.

19. The system of claim 15, wherein the allocation of the set of RA preambles is further based on analysis of the pre-defined prioritization information, service requirements, real-time or near real-time network conditions, capability information associated with one or more of the multiple endpoint devices, and/or indication of urgency associated with the one or more of the multiple endpoint devices.

20. The system of claim 15, wherein the connection comprises at least one of a handover or a radio resource control (RRC) connection reconfiguration.
